(19) United States
(12) Patent Application Publication
(10) Pub. No.: US 2026/0301105 A1
(43) Pub. Date: Oct. 1, 2026

(54) PARALLEL WATERMARKING OF VIDEO CONTENT

(71) Applicant: STARZ ENTERTAINMENT, LLP, Santa Monica, CA (US)

(72) Inventors: Christian B. BISCHOFF, Parker, CO (US); Cody M. WAGGONER, Centennial, CO (US)

(21) Appl. No.: 19/092,424

(22) Filed: Mar. 27, 2025

(51) Int. Cl. G06T 1/00

(52) U.S. Cl. CPC G06T 1/0085; G06T 2201/0053

(57) ABSTRACT

Systems, methods, apparatuses, and computer program products for applying varying watermarks to video content. A method may include receiving a batch of video content comprising at least one file; generating a repository instance comprising at least one received file normalized into one or more predetermined formats; and applying a video watermark to at least one normalized file according to at least one scheduling hierarchy and at least one default configuration template.

### TECHNICAL FIELD

Some example embodiments may generally relate to watermarking of video content. For example, certain example embodiments may relate to systems and/or methods for applying watermarks to video content at staggered intervals in parallel.

### BACKGROUND

Video watermarking refers to techniques that apply or embed identifiers to a video stream, such as a movie or television show. Such identifiers can serve to protect intellectual property rights and demonstrate ownership.

### SUMMARY

In accordance with certain example embodiments, an apparatus may include at least one processor and at least one memory storing instructions that, when executed by the at least one processor, cause the apparatus at least to receive a batch of video content comprising at least one file. The at least one memory and instructions, when executed by the at least one processor, may further cause the apparatus at least to generate a repository instance comprising at least one received file normalized into one or more predetermined formats. The at least one memory and instructions, when executed by the at least one processor, may further cause the apparatus at least to apply a video watermark to at least one normalized file according to at least one scheduling hierarchy and at least one default configuration template.

In accordance with some example embodiments, a method may include receiving a batch of video content comprising at least one file. The method may further include generating a repository instance comprising at least one received file normalized into one or more predetermined formats. The method may further include applying a video watermark to at least one normalized file according to at least one scheduling hierarchy and at least one default configuration template.

In accordance with certain example embodiments, an apparatus may include means for receiving a batch of video content comprising at least one file. The apparatus may further include means for generating a repository instance comprising at least one received file normalized into one or more predetermined formats. The apparatus may further include means for applying a video watermark to at least one normalized file according to at least one scheduling hierarchy and at least one default configuration template.

In accordance with various example embodiments, a non-transitory computer readable medium may include program instructions that, when executed by an apparatus, cause the apparatus to perform at least a method. The method may include receiving a batch of video content comprising at least one file. The method may further include generating a repository instance comprising at least one received file normalized into one or more predetermined formats. The method may further include applying a video watermark to at least one normalized file according to at least one scheduling hierarchy and at least one default configuration template.

In accordance with some example embodiments, a computer program product may perform a method. The method may include receiving a batch of video content comprising at least one file. The method may further include generating a repository instance comprising at least one received file normalized into one or more predetermined formats. The method may further include applying a video watermark to at least one normalized file according to at least one scheduling hierarchy and at least one default configuration template.

In accordance with various example embodiments, an apparatus may include receiving circuitry configured to perform receiving a batch of video content comprising at least one file. The apparatus may further include generating circuitry configured to perform generating a repository instance comprising at least one received file normalized into one or more predetermined formats. The apparatus may further include applying circuitry configured to perform applying a video watermark to at least one normalized file according to at least one scheduling hierarchy and at least one default configuration template.

### BRIEF DESCRIPTION OF THE DRAWINGS

For a proper understanding of example embodiments, reference should be made to the accompanying drawings, wherein:

FIG. 1 illustrates an example of a flow diagram of a method according to certain example embodiments;

FIG. 2 illustrates an example of a transcoding fulfillment process according to some example embodiments;

FIGS. 3A-3B illustrate an example of a timeline of a watermark in video content using two different templates according to various example embodiments;

FIGS. 4A-4C illustrate an example of a JavaScript Object Notation (JSON) according to certain example embodiments; and

FIG. 5 illustrates an example of various network devices according to some example embodiments.

### DETAILED DESCRIPTION

It will be readily understood that the components of certain example embodiments, as generally described and illustrated in the figures herein, may be arranged and designed in a wide variety of different configurations. Thus, the following detailed description of some example embodiments of systems, methods, apparatuses, and computer program products for applying varying watermarks to video content is not intended to limit the scope of certain example embodiments, but is instead representative of selected example embodiments.

There are a variety of video watermarks, including visible and hidden (i.e., invisible). Video watermarks may include any combination of images, text, animation, and logos that are positioned over original video content, and may be inserted into one or more predetermined frames of the original video content. Video watermarks may also be transparent, semi-transparent, or opaque, and may be positioned in various areas of the video content (e.g., in a corner) to minimize interfering with viewing of the video content. The video content may be added (e.g., encoded) with the video watermark during a post-production process, especially during the distribution stage of the video content. However, widely available video editing software may enable users to remove video watermarks, for example, by cropping portions of the frames that contain the video watermarks out of a revised version of the video content, and/or by placing a second watermark (e.g., another logo; black box) over the original video watermark, therein concealing the original video watermark.

Hidden watermarks may provide some advantages to overcome some of the disadvantages of visible watermarks, for example, by concealing where video content should be cut to remove the video watermark. Hidden watermarks may also be hidden from a human eye, and instead require specialized software or tools to identify and recognize the video watermark; for example, a hidden watermark may be applied to one or more pixels in the video content. In addition, the and/or spatial domain (i.e., editing individual pixels) and/or frequency domain (i.e., editing Fourier transform) of the video content may be modified without distorting the appearance of the video content; for example, the discrete cosine transform (DCT) or Fourier transform of the video content may be slightly altered. For example, DCT may revise an entire block of data by generating new coefficients associated with different cosine frequencies in the block.

Whether visible or hidden, video watermarks may convey identifying information in a variety of ways, such as with logos, sounds (e.g., chimes), metadata, barcodes, serial numbers, or other identifiers. Video watermarks may also be compatible with standard video processing standards, including compression/decompression (e.g., H.264/Advanced Video Coding (AVC), VP9, AV1) and encryption/decryption (e.g., Advanced Encryption Standard (AES) cipher in Galois/Counter Mode (GCM), Encrypted Media Extensions (EME)).

In general, the addition of video watermarks can enable verification of the authenticity of the video content, and improve automated copyright enforcement efforts. Furthermore, video watermarks can assist in identifying and tracking illegally distributed video content, such as pirated video content and/or unauthorized early releases. The use of a video watermark can assist brand owners and video content distributors to identify illegally broadcast content.

However, video distributors frequently distribute video content to multiple affiliates, including in multiple countries, different languages, and/or different video formats (e.g., 4K, high definition (HD), high dynamic range (HDR), AV1). Applying the same video watermark to video content for all of these affiliates may only provide limited information on the originating affiliate of that video content. For example, while a video watermark of XYZ uniformly applied to all video content by a distributor may indicate whether the video content is pirated or unauthorized, such a uniform video watermark does not indicate the affiliate source of the video content. However, individually applying unique video watermarks that correspond to a particular affiliate may require significant computing resources to ensure that the video content is watermarked without impacting video quality.

Certain example embodiments described herein may have various benefits and/or advantages to overcome the disadvantages described above. For example, certain example embodiments may automatically apply video watermarks to video content that corresponds with particular affiliate and channel playback parameters, thereby avoiding the need for repetitive and resource-intensive duplication. Thus, certain example embodiments discussed below are directed to improvements in computer-related technology.

In certain example embodiments, video content may be watermarked according to an affiliate-specific template, for example, by offsetting a video watermark (e.g., logo) that is inserted (e.g., transcoded, overlaid) into the video content at an interval specific to an affiliate; the video watermark may or may not overlap with intervals specific to other affiliates. As a result, in the event of a content leak, the affiliate-specific watermark may be used to identify from which affiliate the video content originated. For example, in video content having 60 frames per second (fps), a 30-second watermark may appear at time 00 h:10 m:00 s-00 h:10 m:30 s (e.g., frames 36,000-37,800) for Affiliate 1, at time 00 h:10 m:15 s-00 h:10 m:45 s (e.g., frames 36,900-38,700) for Affiliate 2 (i.e., overlapping with Affiliate 1), and at time 00 h:10 m:45 s-00 h:11 m:15 s (e.g., frames 38,700-40,500) for Affiliate 3 (i.e., not overlapping with Affiliate 1). Thus, all three 30-second watermarks begin to be displayed at different times, with the watermark overlapping only for Affiliates 1 and 2. An analysis may then be performed to identify which frame the watermark begins to appear (i.e., 36,000; 36,900; 38,700), and match that frame with the corresponding affiliate (i.e., Affiliate 1; Affiliate 2; Affiliate 3, respectively).

In another example with a larger number of affiliates, in order to identify the affiliate from which the video content originated, video content may be watermarked for 4 affiliates, where a first appearance of the watermark begins to appear at 10:00 for 10 seconds, beginning with Affiliate 1, and is staggered by 5 seconds between each subsequent appearance with each affiliate. A second appearance may then occur of the same (or a different) watermark, beginning at 45:50 for 10 seconds, beginning with Affiliate 1; however, the watermark for each affiliate would begin when the watermark disappears for the previous affiliate. Thus, the timetable for appearances of the watermark may be as follows:

| Affiliate # | First appearance | Second appearance |
|---|---|---|
| Affiliate 1 | 10 m:00 s-10 m:10 s | 45 m:50 s-46 m:00 s |
| Affiliate 2 | 10 m:05 s-10 m:15 s | 46 m:00 s-46 m:10 s |
| Affiliate 3 | 10 m:10 s-10 m:20 s | 46 m:10 s-46 m:20 s |
| Affiliate 4 | 10 m:15 s-10 m:25 s | 46 m:30 s-46 m:40 s |

Video content may also be watermarked based on any other factors of the video content (e.g., age, high value, low value, syndication). For example, high value video content may be a first-license window from a licensor (e.g., original content), and therefore may be watermarked according to the schedule above. In contrast, low value video content (e.g., re-runs, syndicated) may be identically watermarked for all affiliates, and thus watermarked according to the schedule for Affiliate 1.

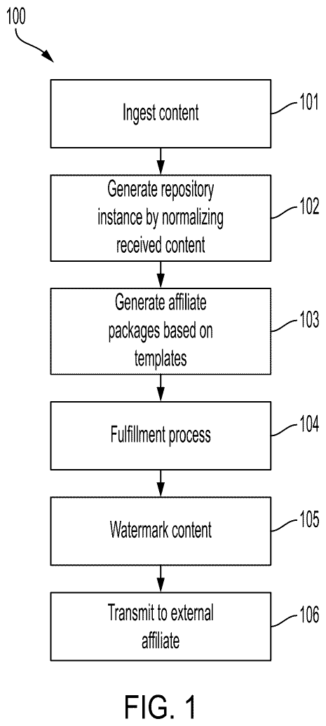

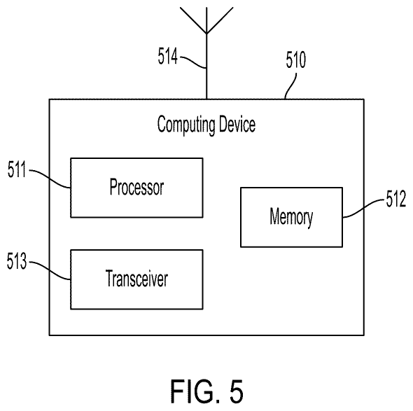

FIG. 1 illustrates an example of a flow diagram of a method 100 that may be performed by a computing device, such as computing device 510 illustrated in FIG. 5, according to various example embodiments.

At step 101, at least one batch of video content may be received (i.e., ingest procedure) by the computing device. Batches of video content may be received from a variety of sources, such as an affiliate, studio (e.g., Sony, Fox), studio lab (i.e., specializing in video/audio coding), and/or other video content sources.

Each batch of video content may include one or more files in one or more file formats. For example, a batch of video content may include any combination and number of video files (e.g., Apple ProRes, Moving Picture Experts Group (MPEG)-2 Video Stream File (M2V) file with a video file having MPEG-2 compression encoding), audio files (e.g., waveform (WAV) audio file format for stereo or surround sound), video/audio multimedia files (e.g., MP4 (i.e., MPEG4) with video or audio data), and/or closed captioning files (e.g., Scenarist Closed Caption (SCC) in a variety of languages (e.g., English, Spanish)).

At step 102, a repository instance of the received video content may be generated. For example, generating a repository instance may include normalizing the files in the received video content into one or more predetermined formats (i.e., same audio format, same video format, same closed caption format, same coder/decoder (codec) formats). Thus, each type of received video content may be converted into a uniform format for the corresponding repository instance. Table 1 below provides an example of two batches of received video content containing 2 different types of content (i.e., Movie 1, Sports Event 1), and the resulting normalized video content for the generated repository instances.

TABLE 1
Repository Instances

| | | | Data | | |
|---|---|---|---|---|---|
| Video | | | format | Data format | |
| Content | Content | | as | (after | Repository |
| Batch | Type | Data type | received | normalization) | Instance |
| 1 | Movie 1 | Video 1 | .AVI | .M2V | 1 |
| 1 | Movie 1 | Audio 1 | .MP3 | .WAV | 1 |
| 1 | Movie 1 | Audio 2 | .MP4 | .WAV | 1 |
| 1 | Movie 1 | Closed | .SRT | .SCC | 1 |
| | | Captioning 1 | | | |
| | | (Spanish) | | | |
| 1 | Movie 1 | Closed | .SCC | .SCC | 1 |
| | | Captioning 2 | | | |
| | | (German) | | | |
| 1 | Sports | Multimedia 1 | .AVI | .M2V | 2 |
| | event 1 | | | | |
| | | [symbol] | .AVI | .WAV | 2 |
| 1 | | Closed | .VTT | .SCC | 2 |
| | | captioning 1 | | | |
| 1 | | Closed | .SCC | .SCC | 2 |
| | | captioning 2 | | | |
| 1 | | Closed | .SRT | .SCC | 2 |
| | | captioning 3 | | | |
| 2 | Movie 1 | Multimedia 1 | ProRes | .M2V | 1 |
| | | [symbol] | .MP3 | .WAV | 1 |
| | Movie 1 | Closed | .SRT | .SCC | 1 |
| | | Captioning 3 | | | |
| | | (English) | | | |

In some instances, the format of received video content may match the format(s) in a given template (e.g., closed captioning 2 (German) for Movie 1 is received as .SCC, but no normalization required). Thus, at least one (or all) of the files in the received video content may not require normalization into a given format; the received video content may be directly added to the corresponding repository instance.

As an example, a repository instance may have a variety of parameters, such as an identifier (ID), type, current status (e.g., Accepted), duration, frame rate (e.g., 29.97 frames per second (fps)), resolution (e.g., 1920×1080), aspect ratio (e.g., 16×9), screen format (e.g., 169FF), primary language (e.g., English), and source media ID.

At step 103, at least one affiliate package may be scheduled to one or more services/channels (e.g., service over the top (SOTT), SIPH, SIP2, SODH), wherein one or more normalized files of the repository instance are scheduled according to an affiliate template. An affiliate package may be generated for each affiliate associated with that service. Each affiliate package may be affiliate-specific and include multiple files. A service may include a group of affiliates.

Each service/channel may be associated with a predetermined set of file formats. In turn, each service/channel may also be associated with one or more affiliates (e.g., Apple, Fubo, Roku, Sling, YouTube), and each affiliate may include an affiliate package with one or more content files. Once individual files are generated, an affiliate may want to receive the individual files of their affiliate package, or may want to receive the files of their affiliate package combined in certain ways. Table 2 below provides an example of a scheduling hierarchy.

TABLE 2
Scheduling Hierarchy

| Repository | | | Affiliate Package Items in |
|---|---|---|---|
| of Content | | | Affiliate Package (according to |
| Type | Service | Affiliate | package template) |
| Movie 1 | Service 1 | Affiliate 1 | .M2V→.MOV |
| | | | .WAV→.AC3 |
| | | | .IMG→.JPG (low-res thumbnail) |
| | | | .IMG→.JPG (high-res pic for |
| | | | season indicator) |
| | | | .IMG→.JPG (high-res pic for |
| | | | other purposes) |
| | | | .SCC (English)→.SRT (English) |
| | | | .META (cast, crew, etc.) |
| | | | (e.g., CableLabs, MovieLabs) |
| | | | .XLS (with similar info, as an |
| | | | alterative to .META, may have |
| | | | information similar to .META) |
| | | Affiliate 2 | .M2V (from repository) |
| | | (according | |
| | | to package | |
| | | template) | |
| | | | .SCC (English) (from repository) |
| | | | .IMG→.JPG |
| | | | .META |
| | | Affiliate 3 | .M2V→.MOV |
| | | (according | |
| | | to package | |
| | | template) | |
| | | | .SCC (English) (from repository) |
| | | | .IMG |
| | | | .META |
| | Service 2 | Affiliate 2 | .M2V→.MOV |
| | | | .SCC (Spanish) |
| | | | .IMG |
| | | | .META |
| | | Affiliate 4 | .M2V→.MOV |
| | | | .SCC (Spanish) |
| | | | .IMG |
| | | | .META |
| | | Affiliate 5 | .M2V→.MOV |
| | | | .SCC (Spanish) |
| | | | .IMG |
| | | | .META |
| | Service 3 | Affiliate 2 | .M2V→.MOV |
| | | | .SCC (English) (from repository) |
| | | | .IMG |
| | | | .META |
| | | Affiliate 3 | .M2V (from repository) |
| | | | .SCC (English) (from repository) |
| | | | .IMG→.JPG |
| | | | .META |
| Movie 2 | Service 1 | Affiliate 1 | .M2V→.MOV |
| | | | .WAV→.AC3 |
| | | | .IMG→.JPG (low-res thumbnail) |
| | | | .IMG→.JPG (high-res pic for |
| | | | season indicator) |
| | | | .IMG→.JPG (high-res pic for |
| | | | other purposes) |
| | | | .SCC (English)→.SRT (English) |
| | | | .META (cast, crew, etc.) |
| | | | (e.g., CableLabs, MovieLabs) |
| | | | .XLS (with similar info, as an |
| | | | alterative to .META, may have |
| | | | information similar to .META) |
| | | Affiliate 2 | .M2V (from repository) |
| | | (according | |
| | | to package | |
| | | template) | |
| | | | .SCC (English) (from repository) |
| | | | .IMG→.JPG |
| | | | .META |
| | | Affiliate 3 | .M2V→.MOV |
| | | (according | |
| | | to package | |
| | | template) | |
| | | | .SCC (English) (from repository) |
| | | | .IMG |
| | | | .META |
| | Service 2 | Affiliate 2 | .M2V→.MOV |
| | | | .SCC (Spanish) |
| | | | .IMG |
| | | | .META |
| | | Affiliate 4 | .M2V→.MOV |
| | | | .SCC (Spanish) |
| | | | .IMG |
| | | | .META |
| | | Affiliate 5 | .M2V→.MOV |
| | | | .SCC (Spanish) |
| | | | .IMG |
| | | | .META |
| | Service 3 | Affiliate 2 | .M2V→.MOV |
| | | | .SCC (English) (from repository) |
| | | | .IMG |
| | | | .META |
| | | Affiliate 3 | .M2V (from repository) |
| | | | .SCC (English) (from repository) |
| | | | .IMG→.JPG |
| | | | .META |

Table 3 below provides an example of an affiliate package template that may be used for scheduling.

TABLE 3
Affiliate Package Template

| Affiliate | Service | Package Item for Affiliate Package |
|---|---|---|
| Affiliate 1 | Service 1 | .MOV |
| | | .AC3 |
| | | .JPG |
| | | .JPG |
| | | .JPG |
| | | .SRT (English) |
| | | .META |
| | | .XLS |
| | Service 2 | .MOV |
| | | .SCC (Spanish) |
| | | .IMG |
| | | .META |
| Affiliate 2 | Service 1 | .MOV |
| | | .SCC (Spanish) |
| | | .IMG |
| | | .META |

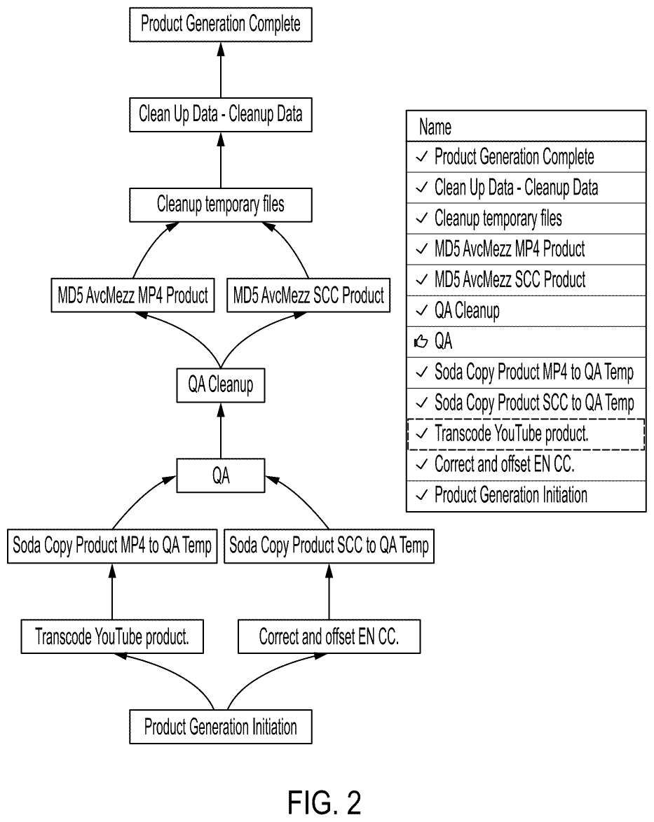

At step 104, for each affiliate package, a fulfillment process may be performed that produces instructions for generating a watermarked product according to a predetermined flow, as shown in FIG. 2. The predetermined flow may be determined according to a template for a particular affiliate.

In particular, as shown in FIG. 2, the fulfillment process may be with a product generation initiation step, which may be performed automatically or manually. Video content may be transcoded according to the affiliate package template, and/or closed captioning may be added or adjusted, as needed. Relevant video files (e.g., .MP4. SCC) may then be fed to a quality assurance check process, followed by any needed corrections or modifications. The needed video files (e.g., .MP4. .SCC) may then be generated, followed by deleting any temporary files.

In some example embodiments, the video watermarks may be added to the video content according to at least one template and at least one configuration. For example, the watermarks may be added according to a template defining at least one of Title, Episode, Service, Origin Identifier, Origin Identifier Name, Origin System, Source Identifier, Source Identifier Name, Source System, Status, Status Description, Start Date, End Date, Schedule Item Identifier, Created Date, and/or Last Updated Date.

Similarly, the watermarks may be generated according to a default configuration template, such as Fade In (e.g., 00:00:00.333), Fade Out (e.g., 00:00:00.333) Start Offset (e.g., 10 minutes), End Offset (e.g., 00:02:00), Interval (e.g., 00:30:00), and Initial Black Duration (e.g., 00:00:02.6667). However, each service/affiliate combination (e.g., Service 2, Affiliate 1; Service 3, Affiliate 4) may have its own default configuration template. The watermarks may be applied according to an affiliate-level configuration, service/affiliate-level configuration, or revert to a default configuration.

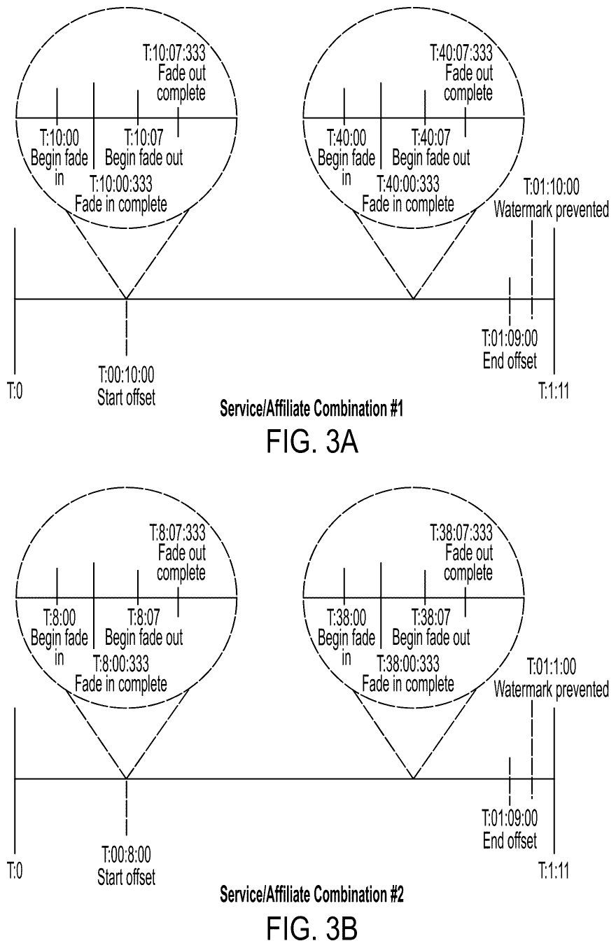

FIGS. 3A-3B illustrate a timeline for watermarking of video content according to the default configuration template shown in Table 4 (below).

TABLE 4
Default Configuration Template

| | Service/Affiliate | | Service/Affiliate | |
|---|---|---|---|---|
| Parameter | Combination #1 | Frame(s) | Combination #2 | Frame(s) |
| Duration | 1 h:11 m:00 s | 255,600 | 1 h:11 m:00 s | 255,600 |
| Initial | 0 h:00 m:02.667 s | 1-3 | 0 h:00 m:02.667 s | 1-3 |
| Black | | | | |
| Start | 0 h:10 m:00 s | 36,000 | 0 h:10 m:05 s | 36,300 |
| offset | | | | |
| Fade in | 00.333 s | 1 | 00.333 s | 1 |
| Interval | 00 h:00 m:07 s | 7 | 00 h:00 m:07 s | 7 |
| Fade out | 00.333 s | 1 | 00.333 s | 1 |
| End offset | 0 h:02 m:00 s | 248,400 | 0 h:02 m:00 s | 248,400 |

In both examples, at 60 fps, the video content has a duration of 1 h:11 m:00 s. Service/affiliate combination #1 has a start offset of 00 h:10 m:00 s, 00.333 s fade in, and 00 h:00 m:07 s duration, while service/affiliate combination #2 has a start offset of 00 h:10 m:05 s, 00.333 s fade in, and 00 h:00 m:07 s duration. Thus, the watermark for service/affiliate combination #1 and service/affiliate combination #2 will overlap by 2 seconds (i.e., 0 h:10 m:05 s-0 h:10 m:07 s).

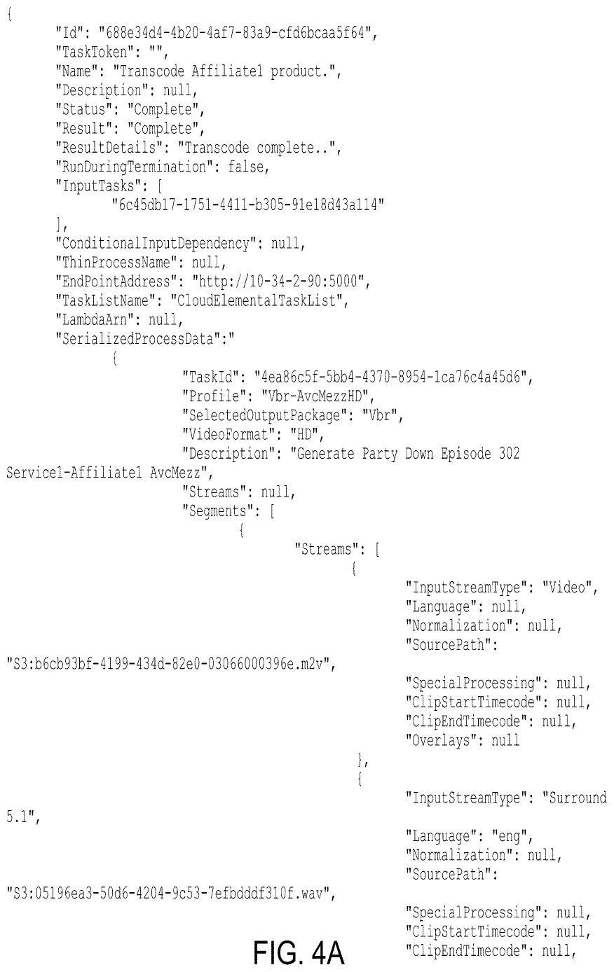

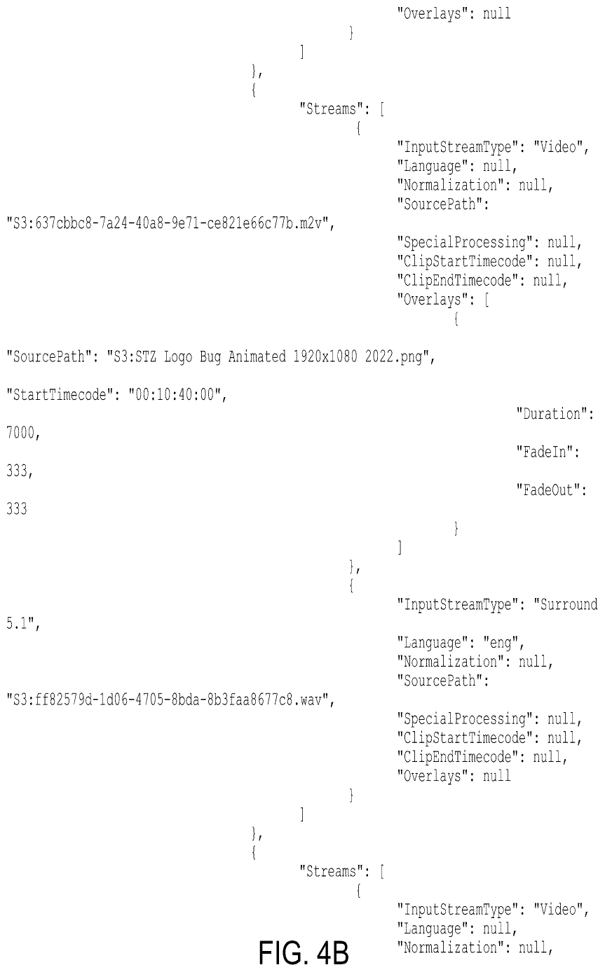

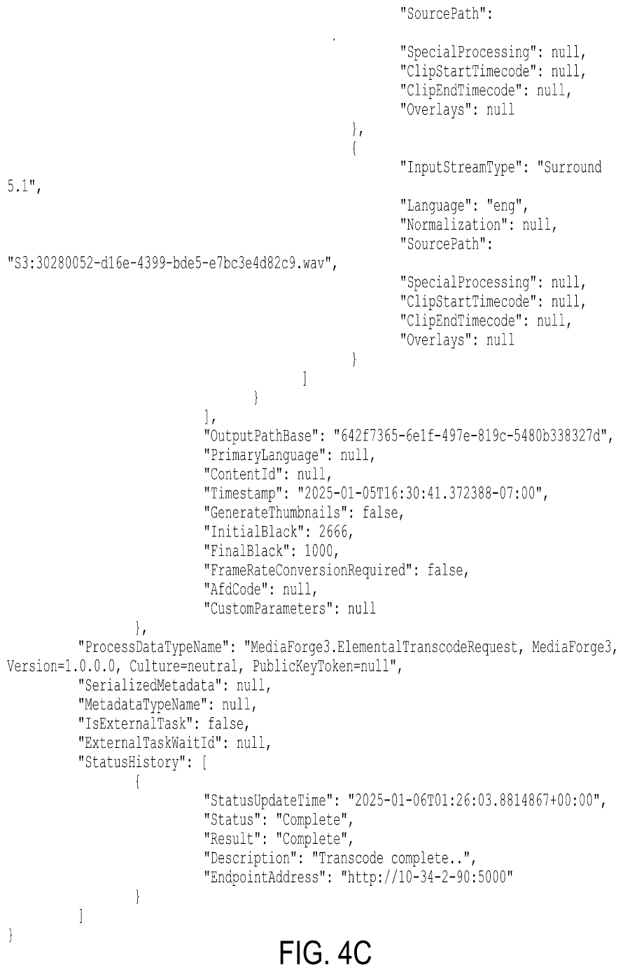

As an example, the fulfillment process may include generating a JavaScript Object Notation (JSON). The JSON instructions may be generated based upon the template, such as shown in FIGS. 4A-C.

At step 105, the video content may be watermarked according to the JSON instructions using a transcoder (e.g., Ateme, Amazon MediaConvert).

At step 106, the watermarked content may be transmitted to the respective affiliate.

FIG. 5 illustrates an example of a system according to certain example embodiments. In one example embodiment, a system may include multiple devices, such as, for example, computing device 510.

Computing device 510 may include one or more of a mobile device, such as a mobile phone, smart phone, personal digital assistant (PDA), tablet, or portable media player, digital camera, pocket video camera, video game console, navigation unit, such as a global positioning system (GPS) device, desktop or laptop computer, single-location device, such as a sensor or smart meter, or any combination thereof. Furthermore, computing device 510 may be one or more of a citizens broadband radio service device (CBSD).

Computing device 510 may include at least one processor, respectively indicated as 511. Processor 511 may be embodied by any computational or data processing device, such as a central processing unit (CPU), application specific integrated circuit (ASIC), or comparable device. The processors may be implemented as a single controller, or a plurality of controllers or processors.

At least one memory may be provided in one or more of the devices, as indicated at 512. The memory may be fixed or removable. The memory may include computer program instructions or computer code contained therein. Memory 512 may independently be any suitable storage device, such as a non-transitory computer-readable medium. The term “non-transitory,” as used herein, may correspond to a limitation of the medium itself (i.e., tangible, not a signal) as opposed to a limitation on data storage persistency (e.g., random access memory (RAM) vs. read-only memory (ROM)). A hard disk drive (HDD), random access memory (RAM), flash memory, or other suitable memory may be used. The memories may be combined on a single integrated circuit as the processor, or may be separate from the one or more processors. Furthermore, the computer program instructions stored in the memory, and which may be processed by the processors, may be any suitable form of computer program code, for example, a compiled or interpreted computer program written in any suitable programming language.

Processor 511, memory 512, and any subset thereof, may be configured to provide means corresponding to the various blocks of FIGS. 1-4. Although not shown, the devices may also include positioning hardware, such as GPS or micro electrical mechanical system (MEMS) hardware, which may be used to determine a location of the device. Other sensors are also permitted, and may be configured to determine location, elevation, velocity, orientation, and so forth, such as barometers, compasses, and the like.

As shown in FIG. 5, transceiver 513 may be provided, and one or more devices may also include at least one antenna, illustrated as 514. The device may have many antennas, such as an array of antennas configured for multiple input multiple output (MIMO) communications, or multiple antennas for multiple RATs. Other configurations of these devices, for example, may be provided. Transceiver 513 may be a transmitter, a receiver, both a transmitter and a receiver, or a unit or device that may be configured both for transmission and reception.

The memory and the computer program instructions may be configured, with the processor for the particular device, to cause a hardware apparatus to perform any of the processes described above (i.e., FIGS. 1-4). Therefore, in certain example embodiments, a non-transitory computer-readable medium may be encoded with computer instructions that, when executed in hardware, perform a process such as one of the processes described herein. Alternatively, certain example embodiments may be performed entirely in hardware.

In certain example embodiments, an apparatus may include circuitry configured to perform any of the processes or functions illustrated in FIGS. 1-4. As used in this application, the term “circuitry” may refer to one or more or all of the following: (a) hardware-only circuit implementations (such as implementations in only analog and/or digital circuitry), (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions), and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

According to certain example embodiments, processor 511 and memory 512 may be included in or may form a part of processing circuitry or control circuitry. In addition, in some example embodiments, transceiver 513 may be included in or may form a part of transceiving circuitry.

In some example embodiments, an apparatus (e.g., computing device 510) may include means for performing a method, a process, or any of the variants discussed herein. Examples of the means may include one or more processors, memory, controllers, transmitters, receivers, and/or computer program code for causing the performance of the operations.

The features, structures, or characteristics of example embodiments described throughout this specification may be combined in any suitable manner in one or more example embodiments. For example, the usage of the phrases “various embodiments,” “certain embodiments,” “some embodiments,” or other similar language throughout this specification refers to the fact that a particular feature, structure, or characteristic described in connection with an example embodiment may be included in at least one example embodiment. Thus, appearances of the phrases “in various embodiments,” “in certain embodiments,” “in some embodiments,” or other similar language throughout this specification does not necessarily all refer to the same group of example embodiments, and the described features, structures, or characteristics may be combined in any suitable manner in one or more example embodiments.

As used herein, “at least one of the following: <a list of two or more elements>” and “at least one of <a list of two or more elements>” and similar wording, where the list of two or more elements are joined by “and” or “or,” mean at least any one of the elements, or at least any two or more of the elements, or at least all the elements.

Additionally, if desired, the different functions or procedures discussed above may be performed in a different order and/or concurrently with each other. Furthermore, if desired, one or more of the described functions or procedures may be optional or may be combined. As such, the description above should be considered as illustrative of the principles and teachings of certain example embodiments, and not in limitation thereof.

One having ordinary skill in the art will readily understand that the example embodiments discussed above may be practiced with procedures in a different order, and/or with hardware elements in configurations which are different than those which are disclosed. Therefore, although some embodiments have been described based upon these example embodiments, it would be apparent to those of skill in the art that certain modifications, variations, and alternative constructions would be apparent, while remaining within the spirit and scope of the example embodiments.

Partial Glossary

| | |
|---|---|
| AC3 | Audio Codec 3 |
| AES | Advanced Encryption Standard |
| ASIC | Application Specific Integrated Circuit |
| AVC | Advanced Video Coding |
| AVI | Audio Video Interleave |
| AWS | Amazon Web Services |
| CBSD | Citizens Broadband Radio Service Device |
| CPU | Central Processing Unit |
| DCT | Discrete Cosine Transform |
| EME | Encrypted Media Extensions |
| FPS | Frames Per Second |
| HDR | High-Dynamic-Range |
| GCM | Galois/Counter Mode |
| GPS | Global Positioning System |
| HDD | Hard Disk Drive |
| IMG | Image |
| IoT | Internet of Things |
| JSON | JavaScript Object Notation |
| M2V | Moving Picture Experts Group-2 Video |
| MEMS | Micro Electrical Mechanical System |
| MIMO | Multiple Input Multiple Output |
| mMTC | Massive Machine Type Communication |
| MP4 | Moving Picture Experts Group Part 4 |
| MPEG | Moving Picture Experts Group |
| PDA | Personal Digital Assistance |
| RAM | Random Access Memory |
| ROM | Read-Only Memory |
| SCC | Scenarist Closed Caption |
| SOOT | Service Over the Top |
| SRT | SubRip Subtitle |
| VTT | Video Text Track |
| WAV | Waveform |
| WLAN | Wireless Local Area Network |
| XGBoost | Extreme Gradient Boosting |
| XLS | Microsoft Excel 97-2003 worksheet |

We claim:

1. A method comprising:
receiving a batch of video content comprising at least one file;
generating a repository instance comprising at least one received file normalized into one or more predetermined formats; and
applying a video watermark to at least one normalized file according to at least one scheduling hierarchy and at least one default configuration template.

2. The method of claim 1, wherein the at least one scheduling hierarchy indicates at least one assignment of at least one service with at least one affiliate, and each assignment is associated with at least one affiliate package.

3. The method of claim 1, wherein the at least one affiliate package indicates at least one file format.

4. The method of claim 2, wherein the at least one default configuration template comprises, for each assignment of at least one service with at least one affiliate, at least one of a display duration, a start offset time, a fade in time, an interval time, a fade out time, and an end offset time.

5. The method of claim 1, wherein a start offset time of a first assignment of at least one first service with at least one first affiliate differs from a start offset time of a second assignment of at least one second service with at least one second affiliate.

6. The method of claim 5, wherein the applying further comprises applying a video watermark to at least one first normalized file at a first start offset time, and applying a video watermark to at least second first normalized file at a second start offset time.

7. An apparatus comprising:
at least one processor; and
at least one memory storing instructions that, when executed by the at least one processor, cause the apparatus at least to:
receive a batch of video content comprising at least one file;
generate a repository instance comprising at least one received file normalized into one or more predetermined formats; and
apply a video watermark to at least one normalized file according to at least one scheduling hierarchy and at least one default configuration template.

8. The apparatus of claim 7, wherein the at least one scheduling hierarchy indicates at least one assignment of at least one service with at least one affiliate, and each assignment is associated with at least one affiliate package.

9. The apparatus of claim 7, wherein the at least one affiliate package indicates at least one file format.

10. The apparatus of claim 8, wherein the at least one default configuration template comprises, for each assignment of at least one service with at least one affiliate, at least one of a display duration, a start offset time, a fade in time, an interval time, a fade out time, and an end offset time.

11. The apparatus of claim 7, wherein a start offset time of a first assignment of at least one first service with at least one first affiliate differs from a start offset time of a second assignment of at least one second service with at least one second affiliate.

12. The apparatus of claim 11, wherein the applying further comprises applying a video watermark to at least one first normalized file at a first start offset time, and applying a video watermark to at least second first normalized file at a second start offset time.

13. A non-transitory computer readable medium comprising program instructions that, when executed by an apparatus, cause the apparatus to perform:
receiving a batch of video content comprising at least one file;
generating a repository instance comprising at least one received file normalized into one or more predetermined formats; and
applying a video watermark to at least one normalized file according to at least one scheduling hierarchy and at least one default configuration template.

14. The non-transitory computer readable medium of claim 13, wherein the at least one scheduling hierarchy indicates at least one assignment of at least one service with at least one affiliate, and each assignment is associated with at least one affiliate package.

15. The non-transitory computer readable medium of claim 13, wherein the at least one affiliate package indicates at least one file format.

16. The non-transitory computer readable medium of claim 14, wherein the at least one default configuration template comprises, for each assignment of at least one service with at least one affiliate, at least one of a display duration, a start offset time, a fade in time, an interval time, a fade out time, and an end offset time.

17. The non-transitory computer readable medium of claim 13, wherein a start offset time of a first assignment of at least one first service with at least one first affiliate differs from a start offset time of a second assignment of at least one second service with at least one second affiliate.

18. The non-transitory computer readable medium of claim 17, wherein the applying further comprises applying a video watermark to at least one first normalized file at a first start offset time, and applying a video watermark to at least second first normalized file at a second start offset time.
